(19) United States
(12) Patent Application Publication
(10) Pub. No.: US 2019/0201257 A1
(43) Pub. Date: Jul. 4, 2019

(54) MOTORIZED WHEELCHAIR

(71) Applicant: Darran Conrad, Gillette, WY (US)

(72) Inventor: Darran Conrad, Gillette, WY (US)

(21) Appl. No.: 15/861,564

(22) Filed: Jan. 3, 2018

(51) Int. Cl. A61G 5/04; A61G 5/10; B62K 11/00

(52) U.S. Cl. CPC A61G 5/04; A61G 5/1091; A61G 2203/18; B60L 2200/34; A61G 2203/14; B62K 11/007

(57) ABSTRACT

Embodiments herein relate to an activation system that may include one or more floorboards with respective holes in the floorboards. The system may further include one or more pushrods positioned adjacent to the holes such that the one or more pushrods are able to extend through the holes to activate one or more switches of a motorized apparatus. The system may further include a clamp to couple with a linear actuator of the motorized apparatus and a switch cam arm coupled with the clamp and the one or more pushrods, wherein the switch cam arm is to facilitate extension of the one or more pushrods when the linear actuator is retracted. Other embodiments may be described and/or claimed.

### TECHNICAL FIELD

Embodiments herein relate to self-balancing motorized systems and more specifically to self-balancing motorized wheelchairs.

### BACKGROUND

Various self-balancing motorized apparatuses exist. One example is a Segway® motorized apparatus which allows a user to stand on the apparatus. When the user stands on the motorized apparatus, one or more gyros may activate which allow the apparatus to self-balance such that the user may ride the apparatus.

### BRIEF DESCRIPTION OF THE DRAWINGS

FIG. 1 depicts an example top down view of a floorboard of a motorized apparatus.

FIG. 2 depicts an example top down view of an activation system, in accordance with various embodiments.

FIG. 3 depicts an example right-side view of an activation system, in accordance with various embodiments.

FIG. 4 depicts an example front-side view of an activation system, in accordance with various embodiments.

FIG. 5 depicts an example perspective view of a portion of an activation system, in accordance with various embodiments.

FIG. 6 depicts an example alternative perspective view of an activation system, in accordance with various embodiments.

FIG. 7 depicts an example front-side view of a motorized apparatus with the activation system thereon, in accordance with various embodiments.

FIG. 8 depicts an example back-side view of a motorized apparatus with the activation system thereon, in accordance with various embodiments.

FIG. 9 depicts an example perspective-side view of a motorized apparatus with the activation system thereon, in accordance with various embodiments.

### DETAILED DESCRIPTION OF EMBODIMENTS OF THE INVENTION

Embodiments of the present disclosure generally relate to a motorized wheelchair. Specifically, embodiments herein generally relate to an activation system that may overlay a pre-existing motorized apparatus such as a Segway® to convert the motorized apparatus into a self-balancing motorized wheelchair. The activation system may do so by attaching to a linear actuator of the motorized apparatus. When the linear actuator is retracted, a linkage may extend one or more pushrods to depress one or more switches of the motorized apparatus, which may result in activation of the gyros of the motorized apparatus. It will be understood that the Segway® is used as an example of such a self-balancing motorized apparatus herein, however embodiments may also be applicable to other self-balancing motorized apparatuses.

In the following detailed description, reference is made to the accompanying drawings that form a part hereof, and in which are shown by way of illustration embodiments that may be practiced. It is to be understood that other embodiments may be utilized and structural or logical changes may be made without departing from the spirit or scope of the present disclosure. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

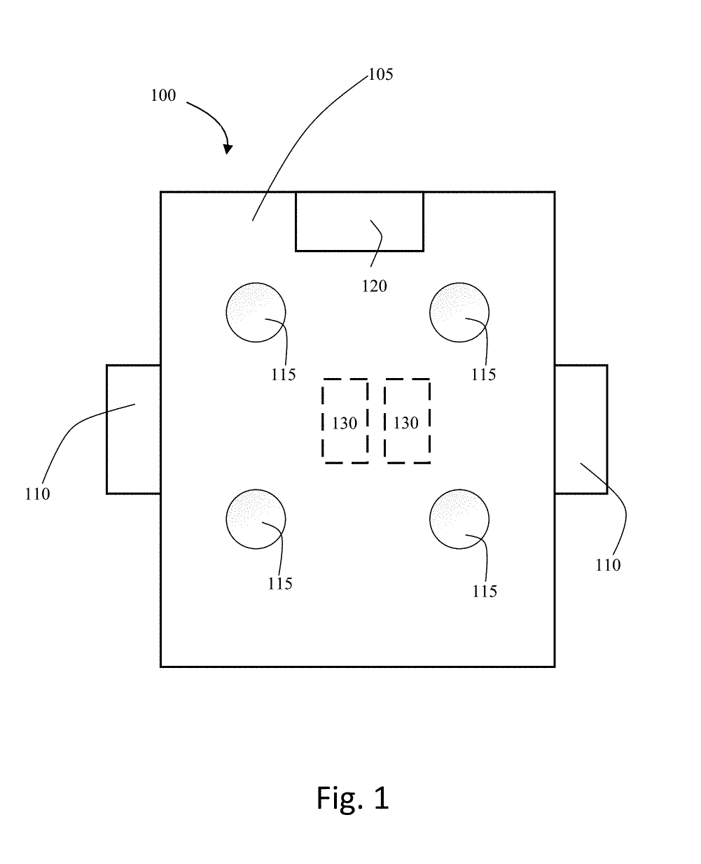

FIG. 1 depicts an example floorboard 105 of a motorized apparatus 100. Specifically, the floorboard 105 may be a floorboard where a user of the motorized apparatus 100 may stand when the motorized apparatus 100 is in use. The floorboard 105 may include a plurality of switches 115 placed therein. The switches 155 may be, specifically, pressure sensitive switches such as toggle switches, push-button switches, or some other type of switch.

More specifically, if a switch 115 is a push-button type switch, it may be configured such that the switch 115 is activated (i.e., “on”) when pressure is applied to the switch 115. When pressure is removed, the switch 115 may be deactivated (i.e., “off”).

The motorized apparatus 100 may further include two wheels 110. As shown in FIG. 1, the wheels may be generally parallel to one another. The motorized apparatus 100 may also include a handlebar or other control apparatus 120. The control apparatus 120 may extend upward from the floorboard 105, which would be out of the page as shown in FIG. 1. As depicted herein, the control apparatus 120 is generally depicted as a “joystick” style control apparatus, however in other embodiments the control apparatus may be, for example, a handlebar style, a wheel style, or computerized and controlled via alternative inputs such as a mouse, a keyboard, voice activation, breath activation, or some other control style.

In operation, when a user is standing on the floorboard 105, the user's feet may depress all four of the switches 115. Specifically, the user may be facing towards the front of the motorized apparatus 100, which would be “up” as depicted in FIG. 1. The user's left foot may depress the two leftmost switches 115 (as shown in FIG. 1) and the user's right foot may depress the two rightmost switches 115 (as shown in FIG. 1). Activation of all four of the switches 115 may cause one or more gyros 130 of the motorized apparatus 100 to activate, which may cause the motorized apparatus 100 to self-balance. The motorized apparatus 100 may then be configured to move forward or backward (up or down as shown in FIG. 1, respectively) by way of the parallel wheels 110. It will be understood that the gyros 130 are illustrated with dashed lines because in some embodiments they may be coupled with a bottom portion of the motorized apparatus 100, and therefore not easily viewable, however the specific location of the gyros 130 may be different in other embodiments. Additionally, although FIG. 1 shows two generally parallel gyros 130, other embodiments may have more or less gyros arranged in different configurations.

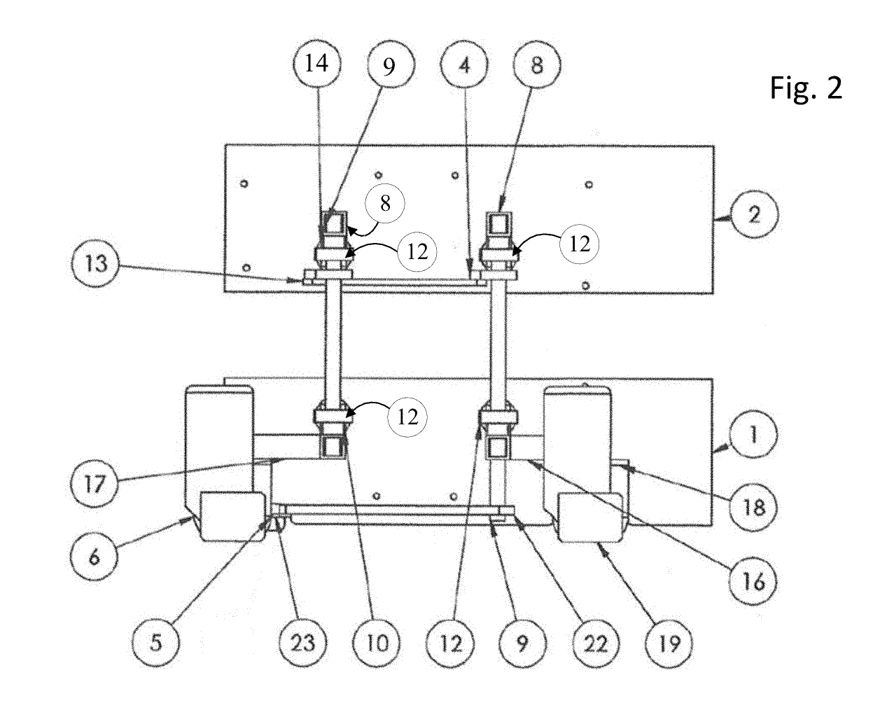

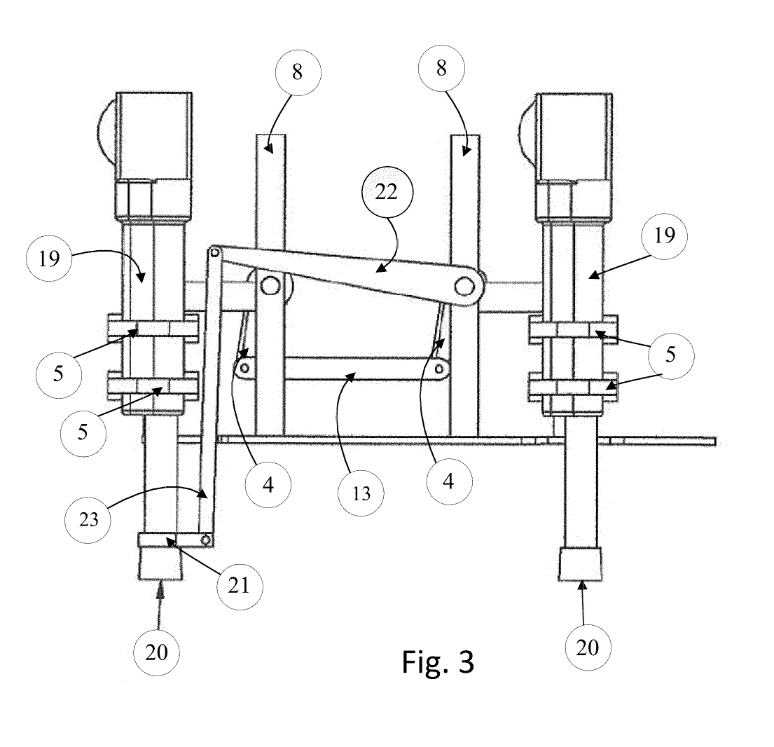

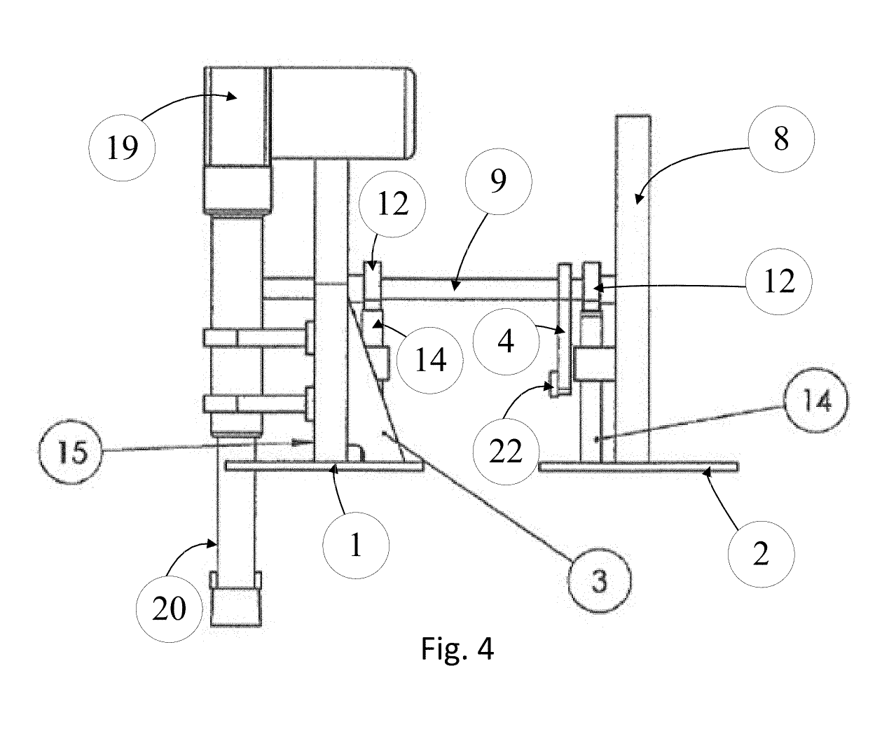

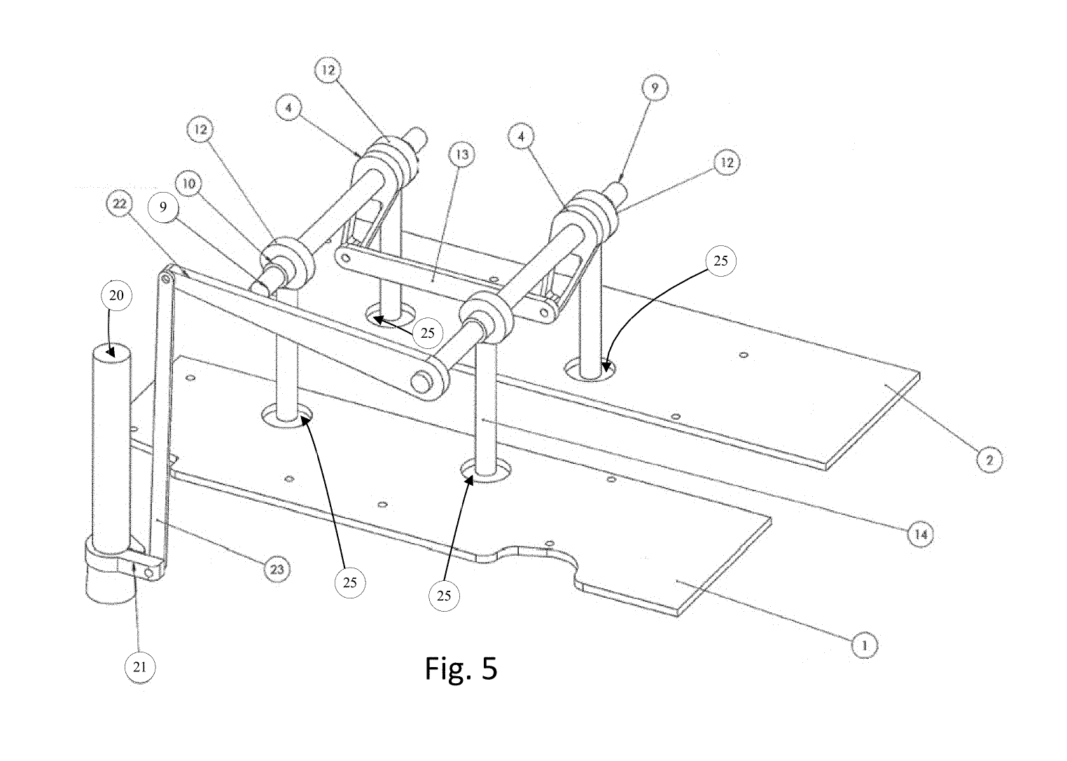

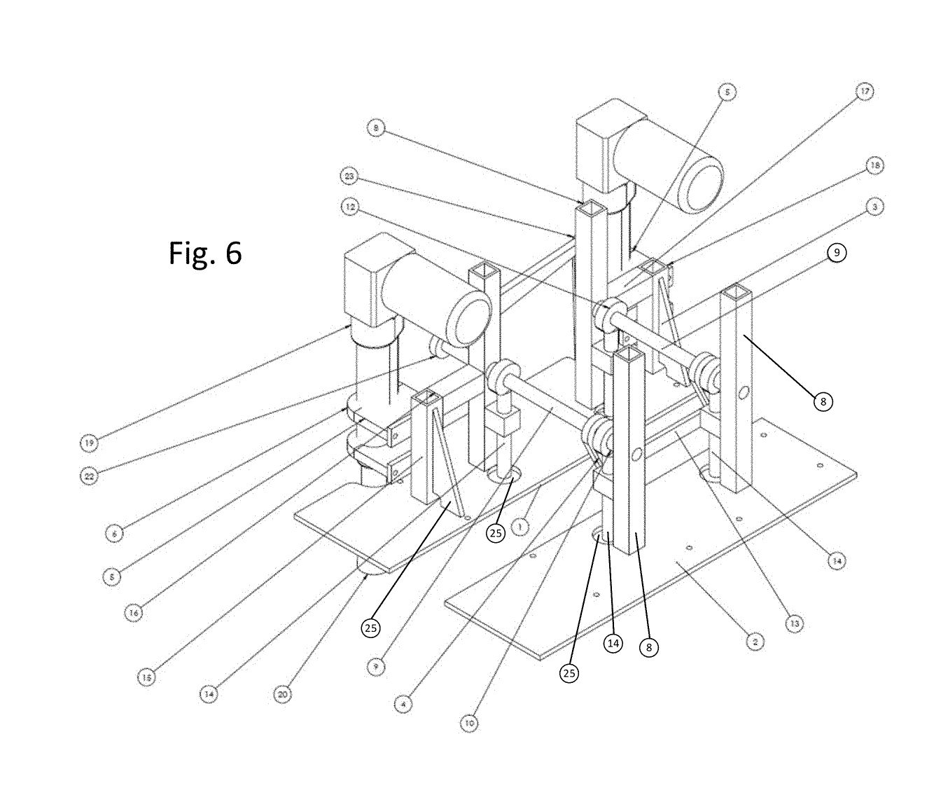

FIGS. 2-6 present various views of an example activation system that may couple with the motorized apparatus 100. Specifically, FIG. 2 depicts an example top down view of an activation system, in accordance with various embodiments. FIG. 3 depicts an example right-side view of an activation system, in accordance with various embodiments. FIG. 4 depicts an example front-side view of an activation system, in accordance with various embodiments. FIG. 5 depicts an example perspective view of a portion of an activation system, in accordance with various embodiments. FIG. 6 depicts an example alternative perspective view of an activation system, in accordance with various embodiments. In general, a person of ordinary skill will recognize that the various FIGS. 2-6 represent different views of the same activation system. Different elements may be more visible or less visible in different ones of the Figures. Each of the Figures may not include labels for each of the elements for the sake of clarity of the Figure itself, or if certain of the elements may not be clearly depicted in the Figure. Additionally, it will be recognized that FIG. 5 is intended to show details of various linkages and connecting elements of the activation system, and certain other elements such as an actuator coupling, a coupling cover, etc. may be removed from the FIG. 5 such that the linkages and connecting elements may be more clearly seen. Throughout FIGS. 2-6, identical labels may be used to identify identical elements. The following description will be made with respect to the labels and elements as shown in the various FIGS. 2-6.

The activation system may include, for example, a linear actuator side floor board 1 and a main floor board 2. As used herein, the term “main” is not intended to denote priority, relative importance, or some other quality related concept. Rather, the term “main” is used herein to distinguish the described elements from elements that may be closer to the linear actuator, and particularly the linear actuator upper 19 and the linear actuator inner slider 20.

The floorboards 1 and 2 may overlay the floorboard 105 of the motorized apparatus 100. The floorboards 1 and 2 may includes holes 25 that may be designed such that when the floorboards 1 and 2 are placed on top of the floorboard 105, the holes 25 may generally line up with switches 115 of the motorized apparatus 100.

The activation system may further include one or more pushrods 14 which may be respectively lined up with the holes 25 such that when the pushrods 14 are extended, they extend through the holes 25. When the floorboards 1 and 2 are overlaid upon the floorboard 105, then the pushrods 14 may activate the switches 115 of the motorized apparatus.

The pushrods 14 may be coupled with a cam shaft 9 via one or more cams 12. For example, as can be seen in FIG. 5, the activation system may include four pushrods 14, and two cam shafts 9. Each of the two cam shafts 9 may be coupled with two of the pushrods 14 via a cam 12. As used herein, a cam 12 may refer to a mechanical device that converts rotational movement into linear movement. The rotational movement may be, for example, rotation of the cam shafts 9. The rotation of the cam shafts 9 may, via the cams 12, be converted to linear movement of the pushrods 14. Some of the cams 12 may further include a cam spacer 10 that may help to separate the cam 12 from a neighboring element.

The cam shafts 9 may be coupled with one another via one or more linkage arms 4 and one or more linkages 13. As can be seen, for example in FIG. 5, the linkage arms 4 may couple with, and extend from, the cam shafts 9. The linkage 13 may couple the two linkage arms 4. One of ordinary skill in the art will recognize that when one of the cam shafts 9 rotates, then a first linkage arm 4 coupled with that cam shaft 9 would also move accordingly. Movement of the first linkage arm 4 would result in movement of the linkage 13, which in turn would result in movement of a second linkage arm 4 coupled with the end of the linkage 13 opposite the first linkage arm 4. Movement of the second linkage arm 4 would then result in movement of the cam shaft 9 that is coupled with that second linkage arm 4. To provide a specific example, described with respect to FIG. 5, there are two cam shafts 9, one on the left and one on the right (with respect to the Figure itself). Both of the cam shafts 9 are coupled with a respective linkage arm 4, and the linkage arms 4 are coupled to opposite ends of a linkage 13. If the cam shaft 9 on the right were to rotate clockwise (with respect to FIG. 5), then the linkage arm 4 would similarly rotate, which would move the portion of the linkage arm 4 coupled with the linkage 13 to the left. This would drive the linkage 13 itself to the left, which would similarly move the linkage arm 4 coupled with the opposite end of the linkage 13 (i.e., the left-most linkage arm 4 with respect to FIG. 5). This would in turn cause the left cam shaft 9 to rotate clockwise. In other words, movement of one cam shaft 9 would, via the linkage 13 and the linkage arms 4, cause identical or approximately identical movement of the other cam shaft 9.

One of the cam shafts 9 may additionally be coupled with a switch cam arm 22. Specifically, the switch cam arm 22 may be coupled with one of the cam shafts 9 at a first end of the switch cam arm 22, and an actuator linkage 23 on an opposite end of the switch cam arm 22.

The actuator linkage 23 may be coupled with a clamp 21 that may also be coupled with a linear actuator inner slider 20. The linear actuator inner slider 20 may be configured to retract into a linear actuator upper 19. The linear actuator inner slider 20 and the linear actuator upper 19 may collectively be referred to herein as the linear actuator, and may be a pre-existing element of the motorized apparatus 100. The linear actuator may be a hydraulic actuator, a mechanical type actuator (i.e., based on a screw or some other mechanical system), an electro-magnetic actuator, or some other type of actuator.

The clamp 21 may couple with the linear actuator inner slider 20 such that retraction of the linear actuator inner slider 20 into the linear actuator upper 19 may cause the clamp 21 itself to move. As used herein, “retraction” of the linear actuator inner slider 20 may refer to movement of the linear actuator inner slider 20 “upwards” with respect to a surface on which the motorized apparatus 100 is sitting. When the linear actuator inner slider 20 and the clamp 21 moves, the actuator linkage 23 may also move. As shown in, for example FIG. 5, the actuator linkage 23 may move upwards. Movement of the actuator linkage 23 upwards may result in movement of the switch cam arm 22, which in turn may result in movement of one or both of the cam shafts 9.

Generally, as can be seen in FIG. 5, the activation system may generally operate such that the linear actuator is the driving force behind movement of the various elements of the activation system. Movement of the linear actuator inner slider 20 may cause, via the clamp 21, the actuator linkage 23, and the switch cam arm 22, movement of the cam shaft 9 with which the switch cam arm 22 is coupled. As shown in FIG. 5, that movement may be generally clockwise rotation of the cam shaft 9. Rotation of that cam shaft 9 may cause, via linkage arms 4 and linkage 13, similar rotation (e.g., clockwise rotation) of the second cam shaft 9 as described above. Rotation of the cam shafts 9 may then cause, via cams 12, extension of the pushrods 4 through the holes 25 of the floorboards 1 and 2.

The activation system may include additional elements as shown in the various Figures. For example, the activation system may include a plurality of actuator couplings 5. The actuator couplings 5 may couple the activation system to the linear actuator upper 19. More precisely, the actuator couplings 5 may couple the activation system to a coupling cover 6 that generally surrounds all or a portion of the actuator couplings 5 or the linear actuator upper 19.

The actuator couplings 5 may further be coupled, via linear actuator bolt plate 18, with one or more linear actuator side uprights 15, which may be coupled with the linear actuator side floor board 1. The linear actuator side uprights 15 may be further supported by one or more gussets 3. The linear actuator side uprights 15 may serve to further couple the activation system to the linear actuator upper 19, and the gussets 3 may serve to prevent the linear actuator side uprights 15 from twisting or rotating when force applied to either the linear actuator, an element of the activation system, or the motorized apparatus itself.

The activation system may include one or more main uprights 8 which may be coupled with the main floor board 2 and the linear actuator side floor board 1. The main uprights 8 may support, for example, a seat 125 in which a user of the motorized apparatus may sit. As shown in FIG. 6, the main uprights 8 may further support the cam shafts 9. In some embodiments, as shown in FIG. 6, the linear actuator side uprights 15 may be coupled with the main uprights 8 by the forward linear actuator strut 16 and the back linear actuator strut 17 (collectively referred to herein as “the struts”). By coupling with the linear actuator side uprights 15, the struts may help to support and reinforce the main uprights 8.

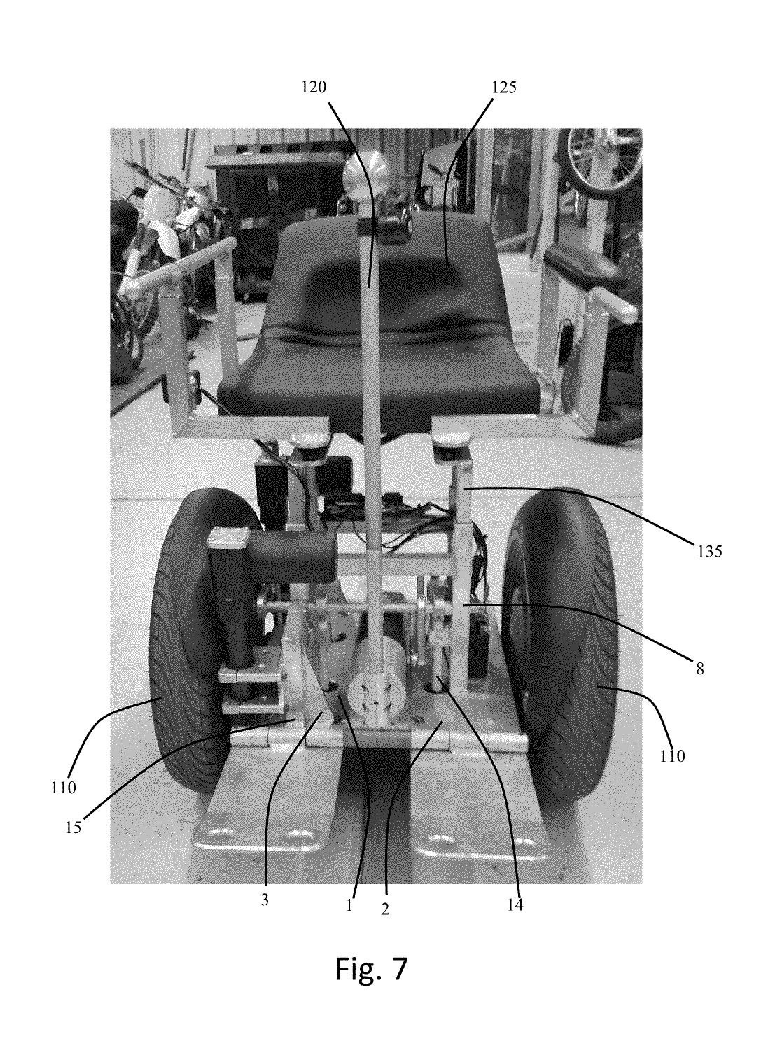

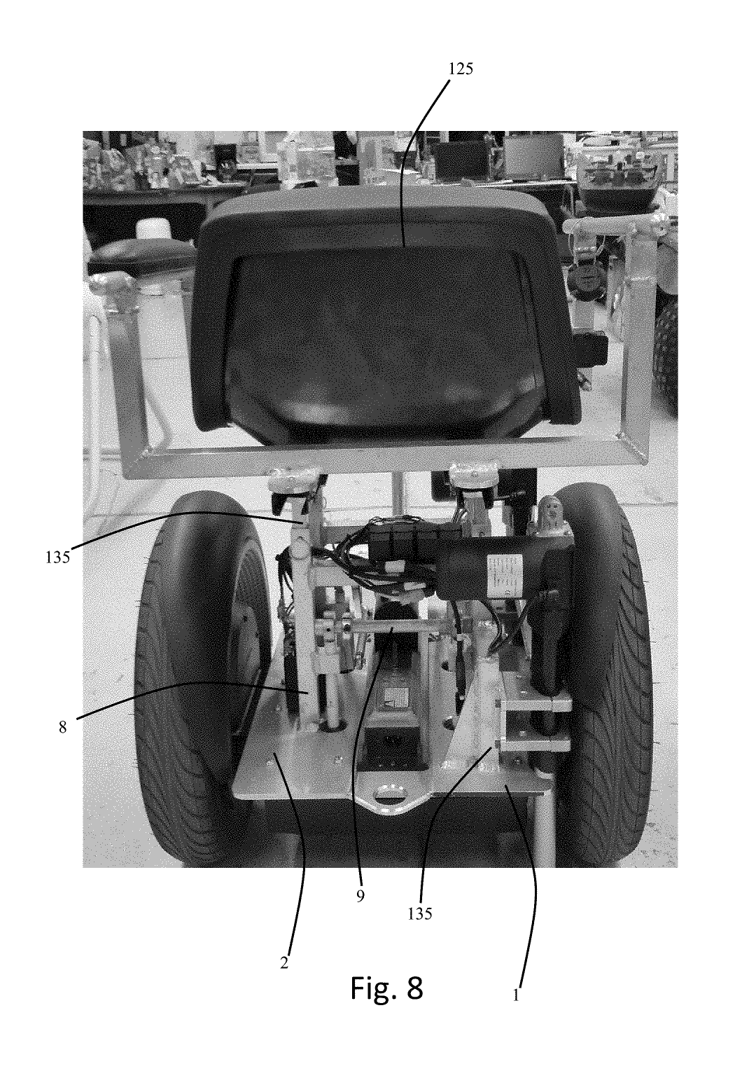

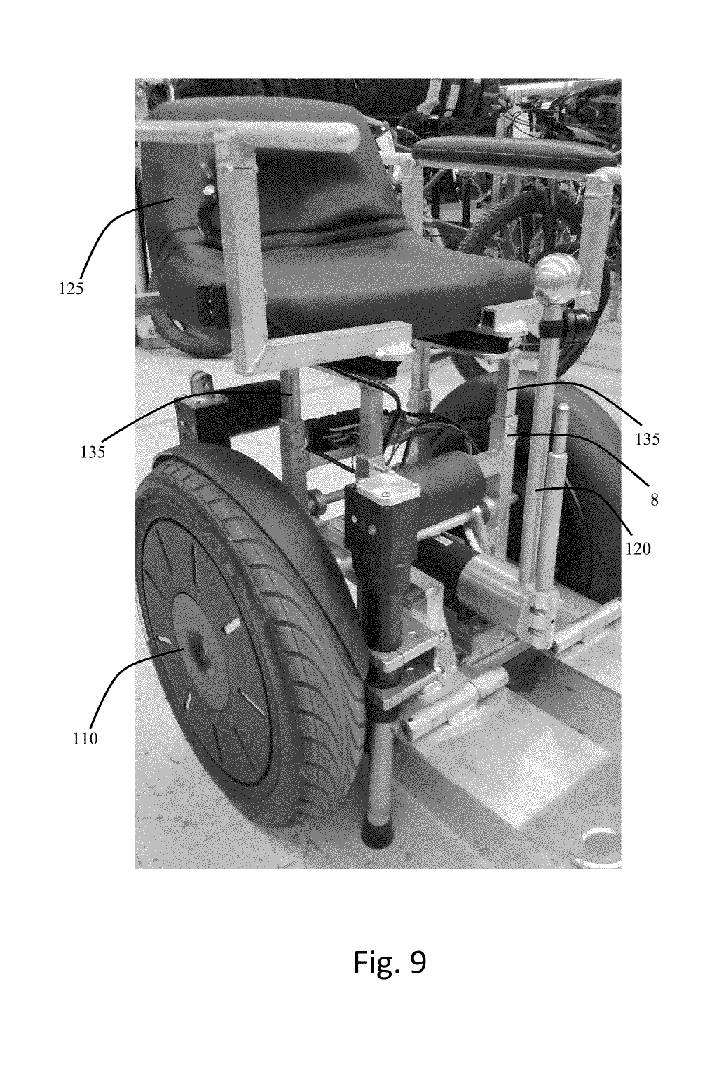

FIGS. 7-9 depict example views of a motorized apparatus with the activation system thereon. Specifically, FIG. 7 depicts an example front-side view of a motorized apparatus with the activation system thereon, in accordance with various embodiments. FIG. 8 depicts an example back-side view of a motorized apparatus with the activation system thereon, in accordance with various embodiments. FIG. 9 depicts an example perspective-side view of a motorized apparatus with the activation system thereon, in accordance with various embodiments. It will be understood that some elements previously depicted in FIGS. 1-6 are numbered in FIGS. 7-9, but for the sake of clarity and conciseness, every element already discussed with respect to FIGS. 1-6 may not be numbered. Lack of explicit numbering of an element from FIGS. 1-6 is not intended to indicate that such element may be missing from FIGS. 7-9.

As can be seen, FIGS. 7-9 depict, for example, a seat 125 in which a user of the motorized apparatus 100 may sit. The user may, from the seat 125, operate the control apparatus 120. The seat 125 may be coupled with the activation system via seat connectors 135. More specifically, the seat connectors 135 may couple the seat 125 with the main uprights 8 of the activation system.

It will be understood that although various elements are depicted with a given shape or in a given number, other embodiments may include a different number of elements or elements with a different shape. For example, the main uprights 8 are depicted as generally square shape though in other embodiments the main uprights 8 (or other elements such as the linear actuator side uprights 15, the struts, or some other elements) may have a different shape such as circular, octagonal, triangular, etc. Additionally, there may be additional element such as additional main uprights 8, additional seat connectors 135, etc. In other embodiments there may be fewer elements such as fewer main uprights 8, fewer linear actuator side uprights 15, etc. Generally, the specific shape or number of elements is intended as illustrative rather than restrictive.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A motorized apparatus comprising:
one or more gyros to cause the apparatus to balance on two wheels;
a chair in which a user of the apparatus may sit;
one or more linear actuators that, when extended, balance the apparatus;
one or more switches in a floor board of the apparatus, wherein the switches when activated, are to activate the one or more gyros and facilitate retraction of the one or more linear actuators; and
an activation system coupled with the floorboard of the apparatus, wherein the activation system includes:
one or more pushrods positioned such that extension of the one or more pushrods activate the one or more switches;
a clamp coupled with one of the one or more linear actuators; and
a switch cam arm coupled with the clamp and the one or more pushrods,
wherein the switch cam arm is to facilitate extension of the one or more pushrods when the one or more linear actuators are retracted.

2. The apparatus of claim 1, wherein the two wheels are parallel with one another.

3. The apparatus of claim 1, wherein the switch is a pressure sensitive switch.

4. The apparatus of claim 1, wherein retraction of a linear actuator of the one or more linear actuators includes vertical movement upward with respect to a surface on which the apparatus is sitting.

5. The apparatus of claim 1, wherein the activation system further comprises:
a first cam coupled with a first pushrod of the one or more pushrods; and
a first cam shaft coupled with the first cam and the switch cam arm.

6. The apparatus of claim 5, wherein movement of the switch cam arm causes the first cam shaft to rotate; and
rotation of the first cam shaft causes, via the first cam, the extension of the first pushrod.

7. The apparatus of claim 6, further comprising a second cam coupled with the first cam shaft and a second pushrod of the one or more pushrods, wherein the rotation of the first cam shaft causes, via the second cam, the extension of the second pushrod.

8. The apparatus of claim 5, wherein the activation system further comprises a second cam shaft coupled with a third pushrod of the one or more pushrods via a third cam;
wherein movement of the switch cam arm causes rotation of the second cam shaft; and
wherein the rotation of the second cam shaft causes, via the third cam, extension of the third pushrod.

9. The apparatus of claim 8, wherein the activation system further comprises a fourth pushrod coupled with the second cam shaft via a fourth cam such that rotation of the second cam shaft causes, via the fourth cam, extension of the fourth pushrod.

10. The apparatus of claim 8, wherein the activation system further comprises a linkage coupled with the first cam shaft and the second cam shaft, wherein rotation of the first cam shaft causes, via the linkage, rotation of the second cam shaft.

11. An activation system comprising:
one or more floorboards with respective holes in the floorboards;
one or more pushrods positioned adjacent to the holes such that the one or more pushrods are able to extend through the holes to activate one or more switches of a motorized apparatus;
a clamp to couple with a linear actuator of the motorized apparatus; and
a switch cam arm coupled with the clamp and the one or more pushrods, wherein the switch cam arm is to facilitate extension of the one or more pushrods when the linear actuator is retracted.

12. The activation system of claim 11, wherein the one or more floorboards are to couple with floorboards of the motorized apparatus.

13. The activation system of claim 12, wherein the one or more switches are pressure sensitive switch positioned within the floorboards of the motorized apparatus.

14. The activation system of claim 11, wherein retraction of the linear actuator includes vertical movement upward with respect to a surface on which the motorized apparatus is sitting.

15. The activation system of claim 11, further comprising:
a first cam coupled with a first pushrod of the one or more pushrods; and
a first cam shaft coupled with the first cam and the switch cam arm.

16. The activation system of claim 15, wherein movement of the switch cam arm causes the first cam shaft to rotate; and
rotation of the first cam shaft causes, via the first cam, the extension of the first pushrod.

17. The activation system of claim 16, further comprising a second cam coupled with the first cam shaft and a second pushrod of the one or more pushrods, wherein the rotation of the first cam shaft causes, via the second cam, the extension of the second pushrod.

18. The activation system of claim 15, further comprising a second cam shaft coupled with a third pushrod of the one or more pushrods via a third cam;
wherein movement of the switch cam arm causes rotation of the second cam shaft; and
wherein the rotation of the second cam shaft causes, via the third cam, extension of the third pushrod.

19. The activation system of claim 18, further comprising a fourth pushrod coupled with the second cam shaft via a fourth cam such that rotation of the second cam shaft causes, via the fourth cam, extension of the fourth pushrod.

20. The activation system of claim 18, further comprising a linkage coupled with the first cam shaft and the second cam shaft, wherein rotation of the first cam shaft causes, via the linkage, rotation of the second cam shaft.
